(19) United States
(12) Patent Application Publication
(10) Pub. No.: US 2024/0355318 A1
(43) Pub. Date: Oct. 24, 2024

(54) INTELLIGENT VIRTUAL ASSISTANT TRAINING THROUGH PHASED OBSERVATIONAL LEARNING TASKS

(71) Applicant: Verint Americas Inc., Alpharetta, GA (US)

(72) Inventor: Ian BEAVER, Spokane, WA (US)

(21) Appl. No.: 18/137,995

(22) Filed: Apr. 21, 2023

(51) Int. Cl. G10L 15/01; G10L 15/06

(52) U.S. Cl. CPC G10L 15/01; G10L 15/063

(57) ABSTRACT

Disclosed embodiments pertain to training an intelligent virtual assistant through phased observational learning tasks. A pre-trained language model can be updated offline to produce a second language model with self-supervised learning based on transcripts of historical interactions between one or more customers, one or more customer service agents, and one or more data stores. The second language model can be evaluated and determined to satisfy a predetermined performance threshold. Subsequently, the second language model can be updated online to produce a third language model with reinforcement learning based on received customer input and similarity between a response provided by a customer service agent and a predicted response generated by the second language model. The third language model can then be deployed with an intelligent virtual assistant to respond to received user input.

### INTRODUCTION

An intelligent virtual assistant (IVA) is a sophisticated software system that simulates a human-like conversational experience through natural language processing (NLP) and machine learning (ML). They are trained on massive datasets of human language and interactions to learn how to recognize intents, manage dialogues, and generate responses. IVAs are increasingly popular and used in many applications, including customer service, personal assistance, and information retrieval.

### SUMMARY

According to one aspect, an intelligent virtual assistant system comprises a processor coupled to a memory. The memory includes instructions that, when executed by the processor, cause the processor to update a pre-trained language model offline to produce a second language model with self-supervised learning based on transcripts of historical interactions between one or more customers, one or more customer service agents, and one or more data stores, determine that the second language model satisfies a predetermined performance threshold, update the second language model online to produce a third language model with reinforcement learning based on received customer input and similarity between a response provided by a customer service agent and a predicted response generated by the second language model, and deploy the third language model to respond to received user input.

According to another aspect, a method of generating an intelligent virtual assistant comprises updating a pre-trained language model offline to produce a second language model with self-supervised learning based on transcripts of historical interactions between one or more customers, one or more customer service agents, and one or more data stores, determining that the second language model satisfies a predetermined performance threshold, updating the second language model online to produce a third language model with reinforcement learning based on received customer input and a similarity between a response provided by a customer service agent and a predicted response generated by the second language model, and deploying the third language model to respond to received user input.

According to yet another aspect, an intelligent virtual assistant method comprises receiving user input, invoking a language model to infer a response to the user input, and outputting the response to the user input. Moreover, the method includes invoking a language model trained by updating a pre-trained language model offline to produce a second language model with self-supervised learning based on transcripts of historical interactions between one or more customers, one or more customer service agents, and one or more data stores, determining that the second language model satisfies a predetermined performance threshold, and updating the second language model online to produce a third language model with reinforcement learning based on received customer input and similarity between a response provided by a customer service agent and a predicted response generated by the second language model. The method further comprises computing a performance score of the language model based on one or more feedback signals associated with user interaction, determining that the performance score fails to satisfy a predetermined minimum threshold, and initiating further training of the language model.

Other aspects provide non-transitory, computer-readable media comprising instructions that, when executed by a processors of a processing system, cause the processing system to perform the aforementioned methods as well as those described herein and a computer program product embodied on a computer readable storage medium comprising code for performing the aforementioned methods as well as those further described herein.

The following description and the related drawings set forth in detail certain illustrative features of one or more aspects.

### DESCRIPTION OF THE DRAWINGS

The appended figures depict certain aspects and are therefore not to be considered limiting of the scope of this disclosure.

FIG. 1 is a block diagram of a high-level overview of an intelligent virtual assistant including phased automatic training.

FIG. 2 is a block diagram of an example phased automatic training system.

FIG. 3 is a block diagram of example phase transitions for a training system.

FIG. 4 is a block diagram of an example online model updating system.

FIG. 5 is a block diagram of an example online training system based on user feedback.

FIG. 6 is a flow chart diagram of an example method of phased automatic training.

FIG. 7 is a flow chart diagram of an example method of an offline training phase.

FIG. 8 is a flow chart diagram of an example method of an online training phase.

FIG. 9 is a flow chart diagram of another example method of an online training phase.

FIG. 10 is a flow chart diagram of another example method of an online training phase.

FIG. 11 is a block diagram of a suitable operating environment for aspects of the phased automatic training system.

To facilitate understanding, identical reference numerals have been used, where possible, to designate identical elements that are common to the drawings. It is contemplated that elements and features of one embodiment may be beneficially incorporated in other embodiments without further recitation.

### DETAILED DESCRIPTION

Training a language model associated with an intelligent virtual assistant (IVA), such as a chat bot, traditionally requires significant human involvement. A language model is generally a machine learning model, such as a neural network, which can be trained to predict the next word in sentence given previous words based on, for example, a learned probability distribution. A language model is typically trained offline utilizing supervised learning and a massive corpus of labeled data that provides an input and corresponding output that enables the model to learn how to recognize intents and generate responses. However, humans are generally required to hand-label training data for supervised learning, which is extraordinarily resource and time consuming. Consequently, crowdsourcing is often employed as a more practical option for labeling data sets for language models. However, crowdsourcing data labeling can produce low-quality or unreliable labels, as third-party labelers may not have sufficient expertise to generate correct labels.

An alternative to offline training is online training using reinforcement learning. In reinforcement learning, a language model is trained in a simulated environment where it receives and learns from feedback on its responses. However, human involvement is again needed to provide the feedback regarding model output while online learning. Thus the constraint associated with having skilled humans involved in the training persists with online learning.

Because of these practical issues, training and updating language models through human-assisted supervised and reinforcement learning happens infrequently. As a result, traditional language models have long intervals between updates and their performance decays during these intervals, reducing their usefulness. The performance decay of such models often leads to poor end-user interactions.

Aspects described herein provide technical solutions to the aforementioned technical problems associated with training and updating an IVA language model. In various embodiments, employment of observational learning tasks provides a technical effect that improves on conventional methods. For instance, self-supervised learning can be performed to update a pre-trained language model based on historical transcripts of interactions between customer service agents and customers without human interaction. In one aspect, training data can also be limited to interactions with identified high-performing agents, increasing the quality of the training data, improving the performance of the language model, and decreasing the time and computing resources needed to train the language model. In another instance, reinforcement learning can be utilized to update a language model based on a comparison of a model-predicted response to a customer service agent's response to live customer input. Direct involvement in training by humans is not required, rather customer service agents can simply service customers. Further, in some aspects the language model can provide recommendations or suggestions to customer service agents concurrently with model training or updating. Furthermore, training can also utilize a phased approach such that a model is updated with a first observational learning task until satisfactory performance is achieved, at which time, a second observational learning task can be initiated. The phased approach can provide continuous training, which mitigates performance degradation by the language model over time that is endemic with conventional models. These and other benefits and advantages will be apparent given the following details.

Various aspects described herein relate to training an automated intelligent virtual assistant through phased observational learning tasks. In a first phase, a pre-trained language model can be updated or fine-tuned offline with self-supervised learning based on transcripts of historical interactions between customers, customer service agents, and data stores. For example, self-supervised learning can perform masked language modeling or sentence reordering utilizing the transcripts. The self-supervised learning can be performed automatically without human involvement based on observations associated with historical user interactions (e.g., customer and customer service agent interactions through a text-based chat interface or through transcribed calls). Ultimately, updating the pre-trained language model through self-supervised learning results in a second language model or second version of the pre-trained model. The second language model can then be evaluated against a first predetermined threshold to determine whether to continue offline self-supervised training or to transition to a second phase of training.

During the second phase of training, the second language model is updated and fine-tuned with reinforcement learning based on live user input and, for example, a similarity between a response provided by a live user (e.g., customer service agent) and a predicted response generated by the second language model. In accordance with one aspect, the customer service agent receives the predicted response from the second language model as a recommendation for responding to the user input thereby aiding the customer service agent while the model is still being trained.

In some aspects, a rating or score of the recommendation from the customer service agent can be input to further aid tuning the second language model. For example, in the second phase, the second language model can be evaluated against one or more performance thresholds. In one instance, if the performance of the second phase language model fails to satisfy a minimum performance threshold, then training can revert to the first phase. On the other hand, if the performance of the second phase language model satisfies the performance threshold, then the overall training process can proceed to a third phase.

In the third phase, the second language model is deployed to respond to live user input. The second language model can further be tuned based on direct or indirect feedback from a user. For instance, a user can rate or score the performance of a response generated by the second language model. Feedback regarding the performance of the second language model can also be based on other indicia, such as whether a conversation being conducted by an IVA employing the second language model is escalated to a customer service agent or a user prematurely terminates an interaction. The second language model is still subject to a performance evaluation in phase three. In one scenario, the second language model can support an initial portion (e.g., percentage) of the total user input queries. The portion can be increased if the language model exceeds one or more performance thresholds related to handling input queries. Similarly, the portion can be reduced if the performance falls below the one or more performance thresholds. Further, if the performance of the second language model fails to satisfy a predetermined minimum threshold, training can revert to the first or second phases, as described above.

### Example System for Phased Automatic Training of an Intelligent Virtual Assistant

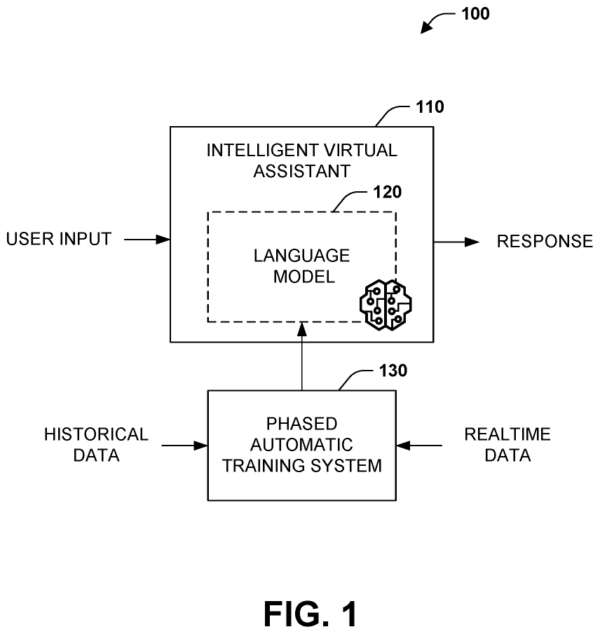

FIG. 1 depicts a high-level overview of an example system implementation for automatically training an IVA in phases. System 100 includes intelligent virtual assistant (IVA) 110, language model 120, and phased automatic training system 130. In this example, IVA 110 is a computer-implemented agent that simulates a human-like conversation experience and provides responses to user input queries. The IVA 110 can extract entities, intent, and sentiment from user input, determine a response based on the intent and context, and produce a text response.

At least one language model 120 can implement the functionality of the IVA 110. In one instance, the language model 120 performs natural language processing tasks, including answering questions. The language model 120 can be implemented with or correspond to, for example, a recurrent neural network (RNN), convolutional neural network (CNN), or transformer models, such as bidirectional encoder representation from transformers (BERT) and generative pre-trained transformer (GPT), among other things. Training of these language models can involve large amounts of text data. The phased automatic training system 130 can utilize a large corpus of data, such as historical call transcripts between customer service agents and customers, to train the language model 120.

Initial generation of machine learning based models, such as the language model 120, is typically referred to as training a model. Subsequent, training is sometimes called retraining, updating, fine-tuning, or adapting the model. However, herein, unless clear by context, the terms training, retraining, updating, fine-tuning, or adapting are used as synonyms, as the terms relate to the learning aspect of a model and improving performance.

The phased automatic training system 130 can train or update the language model 120 in several phases. For example, phase one can correspond to offline model training, and phase two can be associated with online training. Furthermore, the phased automatic training system 130 does not require human-labeled data. Rather, training or updating a model can occur based on observational learning tasks. As a result, a model can be trained and made available for use expeditiously and without the added expense associated with human labels. Training the language mode 120 in this manner substantially reduces training time compared to conventional approaches and can beneficially save resources, including compute, memory, and energy, among other things. Further, observational learning and associated data can be associated with an identified experienced user (e.g., experienced customer service agents) instead of less experienced users (e.g., inexperienced agents or inexperienced third parties). Utilizing high-quality training data (e.g., based on observational learning) generally improves task performance of a language model.

Furthermore, the training can be in phases such that training advances to a subsequent phase after the current phase achieves satisfactory performance. However, training can also revert to a prior training phase if the model fails to satisfy a minimum performance threshold. In this way, training can be implemented as a training state machine. Phase transitions can be performed automatically without human intervention, reducing training time. Further, transitions can also be triggered manually or semi-automatically with limited human intervention. For example, a human can initiate a transition (e.g., manual), a computer process can trigger a transition (e.g., automatic), or a computer process with permission or other input from a human can cause a transition (e.g., semi-automatic) Further yet, the phased automatic training system 130 can continuously train and adapt the language model 120 in view of recent historical data to mitigate task performance decay over time associated with conventional static language models.

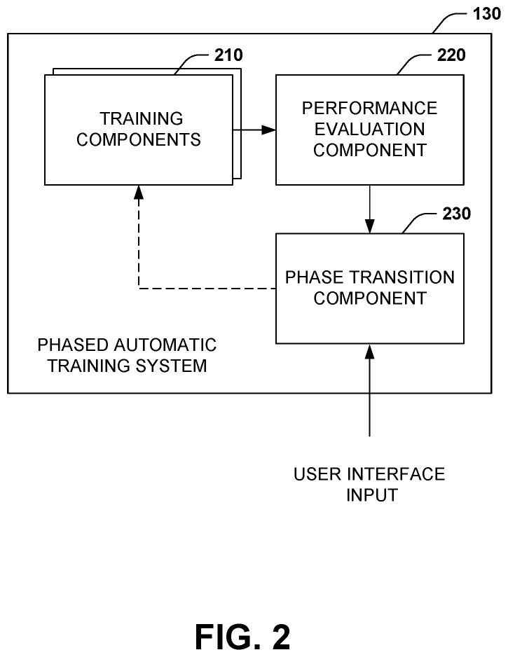

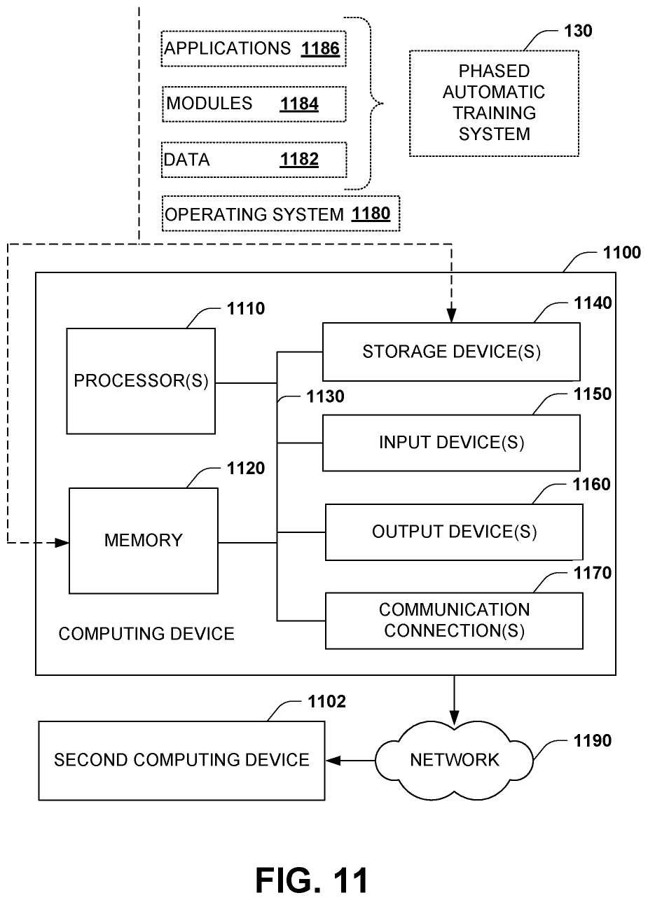

FIG. 2 illustrates a block diagram of an example implementation of the phased automatic training system 130. The phased automatic training system 130 includes training components 210, performance evaluation component 220, and phase transition component 230. The training components 210, performance evaluation component 220, and phase transition component 230 can be implemented by a processor 1110 (FIG. 11) coupled to a memory 1120 (FIG. 11) that stores instructions that cause the processor to perform the functionality of each component when executed. Consequently, a computing device can be configured to be a special-purpose device or appliance that implements the functionality of the phased automatic training system 130. Further, all or portions of the phase automatic training system 130 can be distributed across computing devices or made accessible by way of a network service.

The training components 210 correspond to components associated with particular phases of training in which a distinct training component 210 per phase. In one instance, model training or updating can include an offline and an online phase. Accordingly, a training component of the training components 210 can exist for each of the offline and online phases. The training components 210 can differ between phases. For example, an offline phase can include a component that implements self-supervised learning, while an online phase component implements reinforcement learning. Further, a phase can include a plurality of sub-phases with corresponding training components 210. For example, the offline phase can include several sub-phases for updating a language model for a particular domain, as well as accessing and utilizing external documents in a knowledge base to produce responses, among other things.

The performance evaluation component 220 can evaluate the performance of a language model at various times throughout training or updating. For example, the performance evaluation component 220 can evaluate the performance at a particular phase given a predetermined performance threshold required to advance to another phase. The performance evaluation component 220 can also evaluate performance at a phase given a predetermined minimum performance threshold. In certain embodiments, the predetermined performance threshold and the minimum performance threshold can be distinct thresholds. For example the predetermined performance threshold can be greater than the minimum performance threshold. Satisfying the minimum performance threshold can correspond to performance at or below the threshold and satisfying the predetermined performance threshold corresponds to meeting or exceeding the threshold. Of course, a language model's performance can be between the thresholds such that training can continue without advancing or reverting to another phase.

Performance can be evaluated utilizing test data not used as training data. The language model 120 can be invoked with the test data and generate outputs (sometimes referred to as inferences or predictions). The model output can be compared with known correct outputs (e.g., labels) to compute a performance metric for the language model. The performance metric can capture the difference between the generated output and the known correct output, which is sometimes referred to as an error distance. Improved performance can be associated with a reduced error distance, whereas degraded performance can be linked to an increase in the error distance. Alternatively, the performance metric can measure the similarity or accuracy of a generated output compared to the known output. For example, that performance metric can be “0.80,” which indicates the language model was able to generate a correct response eighty percent of the time for the test data. Error distance and similarity or accuracy are duals in that they are substantially opposite. For example, a similarity of eighty can also be deemed an error distance of twenty out of one hundred.

The phase transition component 230 is configured to trigger transitions between phases of training or updating. For example, phase transitions can be triggered based on performance thresholds. Accordingly, the phase transition component 230 can interact with performance evaluation component 220 to determine whether a threshold is satisfied.

For example, if a performance threshold is satisfied, the phase transition component 230 can trigger a transition from first phase training (e.g., offline training) to second phase training (e.g., online training). Alternatively, if performance fails to satisfy a minimum threshold, the transition component 230 can halt current training and revert to a prior training phase. Thus, the phase transition component 230 can transition training between phases automatically based on performance thresholds.

In some cases, a user may manually trigger the phase transition component 230 via a user interface. For instance, if a new product or feature is released or about to be released, a user can trigger retraining at a different phase to enable a language model to be responsive to inquiries regarding the new product or feature. Further, a human could initiate performance testing and manually trigger the phase transition component 230 to perform training at a different phase. In this manner, rather than waiting for a drop in performance based on new information, a user can manually trigger retraining or updating to minimize performance degradation.

### Example Phase Transitions for Automatic IVA Training

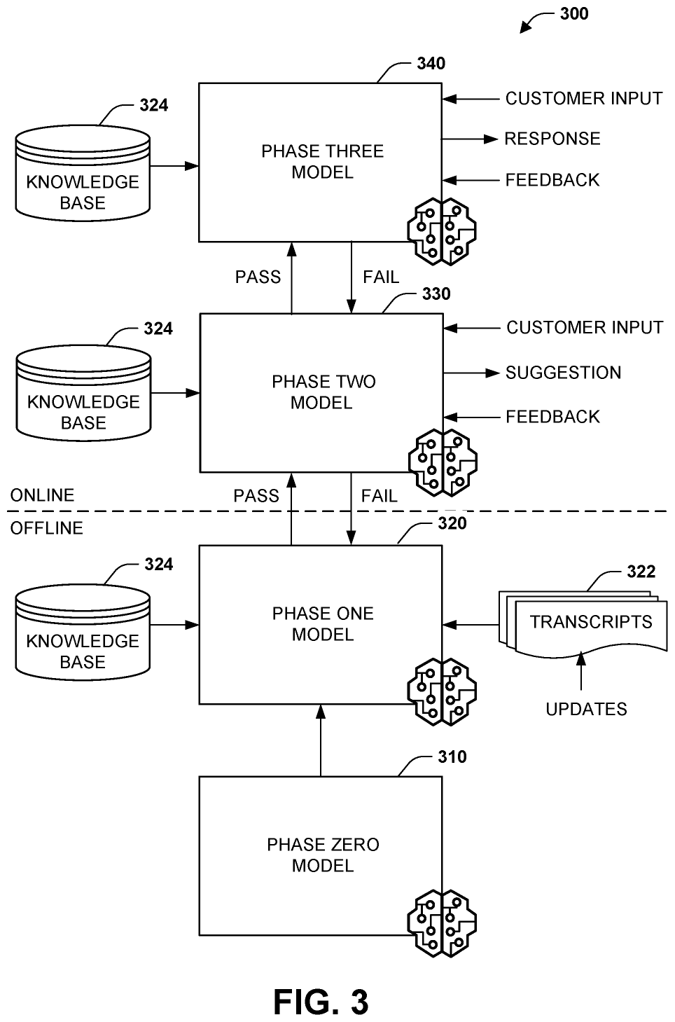

FIG. 3 is a block diagram of example phase transitions. Illustrated are four language models at various training states: phase zero model 310, phase one model 320, phase two model 330, and phase three model 340. As described further below, in a first phase a generic language model is updated for a particular domain based on historical data. In a second phase, the domain specific model is trained on live customer input and a customer service agent's response. The domain specific model is essentially updated further by observing how a customer service agent addresses live input from users. Further, the customer service agent can directly or indirectly provide feedback to the language specific model which can be utilized to updated and improve the model. In a third phase, a language model is updated based on performance of the language model on its own in addressing user input.

Phase zero model 310 is a starting language model. In one instance, phase zero model 310 can be a pre-trained language model, such as GPT or BERT, trained to understand language generally, but not for a specific task. Starting with a pre-trained language model substantially reduces the time required to produce a language model for a particular domain. However, in other cases, the phase zero model 310 may be untrained.

In phase one, phase zero model 310 may be trained offline in order adapt it to a particular domain transition and thereby to transition to a phase one model 320. In some cases, historical transcripts 322 of interactions between customer service agents and users as well as a knowledge base 324 can be utilized to update or adapt the phase zero model 310 to phase one model 320.

In accordance with one implementation, self-supervised learning can be employed utilizing the historical transcripts 322. Self-supervised learning requires no human intervention and can, for example, correspond to masked language modeling (MLM), sentence reordering, or like techniques. MLM involves masking a percentage of words in the input text and training a model to predict the masked words based on the context of the non-masked words. Sentence reordering comprises shuffling sentences in an input paragraph and training a model to predict the sentence order.

In one instance, the historical transcripts 322 can be selected from a subset of customer service agents that qualify as high-performing customer service agents based on experience, recommendation, evaluation, or combination. In this manner, interactions between high-performance customer service agents and users can be utilized as training data instead of interactions between new or poorly performing customer service agents and users to improve the training of phase one model 320.

The knowledge base 324 corresponds to a database or other data store that provides information that can be retrieved and utilized in a generated response. Consider, for example, an intelligent virtual assistant associated with an insurance company. A user might ask if their insurance policy covers a particular event. The intelligent virtual assistant could utilize the knowledge base 324 to determine a customer's policy and covered events in formulating a response.

In accordance with one embodiment, updating the phase zero model 310 to produce the phase one model 320 can involve multiple steps (or sub-phases). For instance, training the phase zero model 310 can first involve generating generic templatized responses relevant to an industry or market in response to customer input. For example, historical transcripts of interactions can be anonymized by inserting placeholders for names, locations, times, and amounts, among other things. The templatized responses can then be used in self-supervised learning to produce templatized agent responses. In another step of updating, agents actions can be recorded with respect to the knowledge base 324. For example, an action, such as a customer service agent reading a document, can be added as a label or metadata with respect to a placeholder. Another step can train the model to replace the placeholder in a templatized response with information retrieved from the knowledge base 324 per the label associated with the placeholder. Another step is to update the model to provide complete responses to input queries.

The performance of the generated phase one model 320 can be evaluated at various times, for instance by the performance evaluation component 220 of FIG. 2 If the performance of the generated phase one model 320 satisfies a predetermined threshold, phase one offline updating can be terminated, and phase two online updating can be initiated.

In phase two, the phase one model 320 (e.g., output of phase one) is updated to generate a phase two model 330. Updating is online, which can correspond to training on live, real customer input data. A customer service agent can receive customer input and generate a response. The phase one model 320 can generate a response to the customer input utilizing the knowledge base, if needed. The model response can then be compared to the customer service agent response to determine a similarity score or error distance between model response and the customer service agent response. Reinforcement learning can be employed in phase two, and a reward or penalty is applied based on the similarity score or error distance. By attempting to maximize a reward, reinforcement learning updates the model and subsequently provides a response that more closely resembles that of a human customer service agent.

In one scenario, reinforcement learning is performed in the background, invisible to the customer service agent. In another scenario, the model-generated response or several candidate responses can be provided to the customer service agent. Interaction with the candidate responses can be monitored and utilized as additional feedback for updating the model. For example, a reward can be assigned if the customer service agent utilizes one of the candidate responses in an actual response to a user. Additionally, an agent may provide feedback regarding the candidate responses (e.g., a rating, thumbs up/down, number of stars), which can then be used as a basis for a reward provided to the reinforcement learning algorithm.

At various points during training in phase two, the phase two model 330 can be evaluated. More specifically, the performance of the phase two model 330 can be determined on a regular basis (e.g., at a set interval of model outputs or over a set amount of time). The performance can be determined by sending test input to the phase two model 330 and comparing a generated response with a preferred response. If the performance of the phase two model 330 satisfies a predetermined threshold level of performance, phase two can be terminated, and phase three can be initiated. By contrast, if the performance of the phase two model fails to satisfy a minimum level of performance, training can revert to phase one training. Alternatively, phase two training can continue without providing candidate responses to the customer service agent In other words, the model's output can be disconnected from a customer service agent to avoid distracting the agent with faulty candidate responses. The output can be reconnected after the model satisfies the minimum level of performance. The performance thresholds can seek to capture whether or not the model has learned enough about a domain to progress to the next phase of updating or if further training about the domain is needed.

In phase three, the phase three model 340 is enabled to respond to live customer input. However, the model can continue to be updated based on direct or indirect feedback from users. For example, a reward can be provided if an interaction finishes successfully or without issue. By contrast, a penalty can be applied if the interaction is escalated to a customer service agent or the customer prematurely cuts off the conversation. By seeking to maximize reward in a reinforcement learning situation, the phase three model will continue to improve responses. Further, the user can be provided with a mechanism to rate the conversation, which can be utilized as additional feedback when determining a reward or penalty in a reinforcement learning scenario.

Model performance can be determined at various points in time. Further, the performance can be compared with one or more predetermined performance thresholds. For example, performance evaluation component 220 of FIG. 2 can determine model performance. The model can be responsible for a relatively small percentage of customer input in one instance. In this situation, if the performance satisfies a predetermined threshold, the percentage of customer input can be increased. On the other hand, if the performance fails to satisfy a predetermined minimum threshold, training can revert to phase two or phase one. Alternatively, customer input can be decreased and subsequently increased after performance improves. For example, the input can be limited to a subset of a particular type of input (e.g., password changes) to allow the model to improve with respect to one category before exposing the model to additional types of input.

### Example Online Model Training Systems

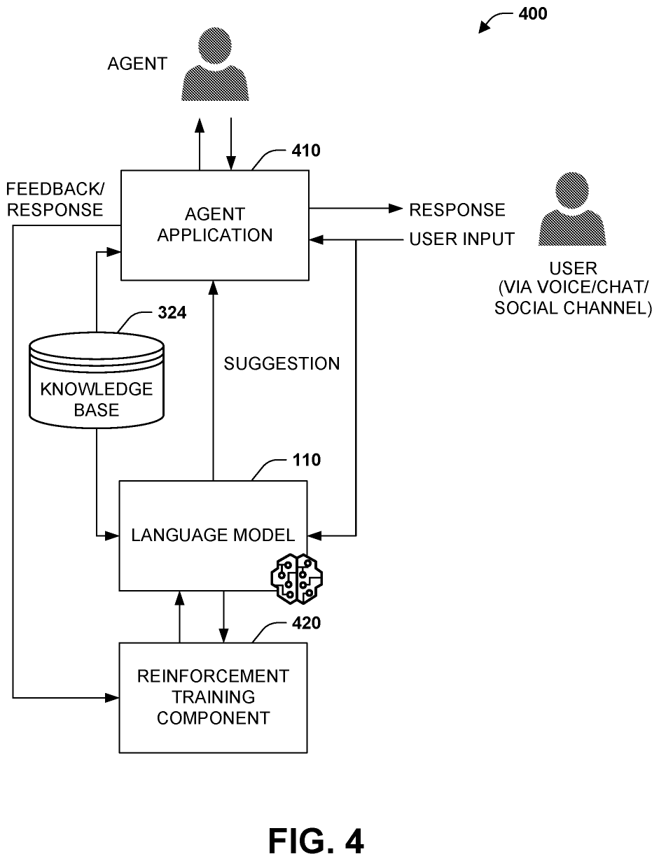

Turning attention to FIG. 4, a block diagram of an example online model updating system 400 is illustrated. In one aspect, the system 400 can correspond to phase two as described and depicted with respect to FIG. 3.

Agent application 410 is a software application employed by agents to enable interaction with users. The agent application 410 can execute on a local computer or as a network service on a remote server. The agent application receives user input, such as a question from a customer or potential customer. The user input can be provided through various channels such as voice, chat, or social channels, among other things. An agent, such as a customer service agent, can view the user input, generate a response, and send the response back to the user. In generating the response, the agent can utilize the knowledge base 324 to look up any needed information. The language model 120 can also be provided with the user input alone or in combination with information from the knowledge base 324 can generate a response. The response can be provided to the reinforcement training component 420.

The reinforcement training component 420 can receive the response generated by the language model 120 and the response constructed by an agent through the agent application 410. The reinforcement training component 420 can compare the two responses and compute a similarity score that represents the similarity or dissimilarity of the two responses. A reward or penalty (e.g., negative reward) is determined based on the similarity score and a reward model or strategy that specifies a mapping between a reward and similarity score that seeks to maximize prediction accuracy by maximizing similarity or minimizing dissimilarity maintained by the reinforcement training component 420. The language model is then updated based on the reward or penalty. In accordance with one embodiment, the language model 120 can provide a predicted response as a candidate response to an agent through the agent application 410. Direct or indirect feedback from the agent regarding the candidate response can further be utilized to update the language model. For example, if an agent selects the candidate response for the agent's response (e.g., indirect feedback) or rates the suggestion positively (e.g., thumbs up, five stars) (e.g., direct feedback), this feedback can result in a reward associated with reinforcement learning. By contrast, if the user does not use the suggestion or rates the suggestion negatively, this feedback can result in a negative reward or penalty.

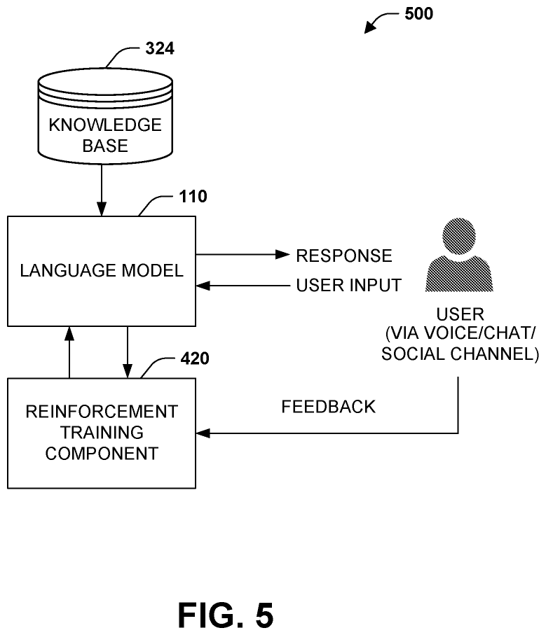

Referring to FIG. 5, a block diagram of a system 500 for online training based on user feedback is depicted. In one aspect, the system 500 can correspond to phase 3 as described and depicted with respect to FIG. 3. Similar to system 400 of FIG. 4, the system 500 includes the language model 120, knowledge base 324, and reinforcement training component 420. However, the language model 120 in the system 500 receives input and responds to a user directly. In this instance, the language model 120 is deemed adequately updated to permit direct interaction with human users, which is a training goal. However, the language model 120 can continue to be updated for continuous performance improvement.

In the example of FIG. 5, a user can provide direct or indirect feedback regarding a response. For example, a mechanism can be made available to rate or otherwise provide feedback regarding responses. Alternatively, observed actions of the user can be captured and utilized as feedback. For instance, feedback can be deemed negative if the conversation is elevated to a human customer service agent or communication is terminated unusually. By contrast, the feedback may be positive if the communication completes without issue. Regardless, the reinforcement training component can employ feedback to update the language model 120.

### Example Methods of Phased Automatic Training

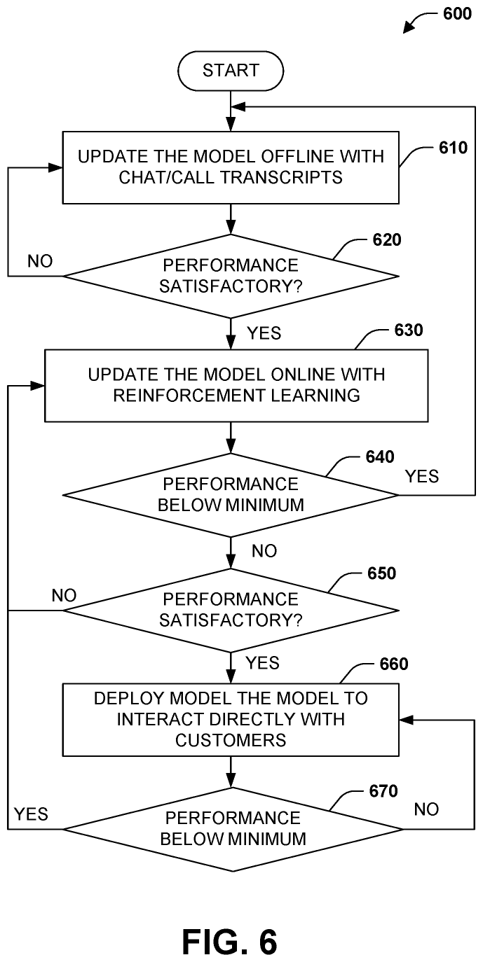

FIG. 6 depicts a flow chart diagram of an example method 600 of phased automatic training. The method 600 can be implemented by the phased automatic training system 130 described above with respect to FIG. 1.

Method 600 starts at block 610 with updating a language model offline with chat or call transcripts. In one instance, a pre-trained language model can be updated based on historical transcripts of interactions between customer service agents and users or customers. Of course, a pre-trained model need not be utilized. In this situation, a language model would first be created, and subsequently, the language model could be updated utilizing the historical transcripts . . .

Method 600 then proceeds to block 620 with determining whether or not the performance of the current language model 120 is satisfactory. In one example, the determination can be based on the accuracy of the language model 120 in predicting responses. In one instance, test data that specifies a user input and a preferred response drafted by a human customer service agent can be utilized. A similarity score can be computed between a model-generated response and a response crafted by a customer service agent. A performance score can be computed based on the similarity scores associated with the test data. The performance score can then be compared with a predetermined threshold. If the performance score satisfies the predetermined threshold (“YES”), then the method continues at 630. If the performance score fails to satisfy the predetermined threshold (“NO”), then the method returns to 610, where offline training of the model continues.

Method 600 then proceeds to block 630 with updating the language model 120 online with reinforcement learning. In accordance with one aspect, live user input directed to a customer service agent is also provided to the language model 120. The provided response by the customer service agent can be compared with a predicted response by the language model 120. For example, a similarity score can be computed that measures the similarity or dissimilarity of the two responses. If the similarity score indicates that the two responses diverge significantly, the language model 120 is penalized in a reinforcement learning scenario. Alternatively, if the similarity score indicates the two responses are substantially similar within a threshold, the language model 120 is rewarded. In accordance with one implementation, the predicted response can be provided to the customer service agent as a candidate response to a query received by the customer service agent. In this situation, if the customer service agent responds with the candidate response, the language model 120 is rewarded and is otherwise penalized. A mechanism can also be employed that solicits feedback in the form of a rating of the customer service agent as to the quality of the candidate response (e.g., thumbs up, thumbs down, five stars). This feedback can also be employed with reinforcement learning to penalize or reward the language model 120 accordingly.

Method 600 then proceeds to block 640 with determining whether performance of the language model 120 is below a predetermined minimum level. In other words, the determination is whether or not the language model 120 satisfies a minimum performance threshold. Model performance can be determined based on test data and the degree of similarity or dissimilarity between how a human customer service agent responded to user input in the test data and the predicted response of the model to the user input. A similarity score can be computed between a predicted response and a response by a customer service agent. A performance score can be computed based on the similarity scores associated with the test data. The performance score can then be compared with a predetermined minimum threshold. If the performance score fails to satisfy the minimum threshold (“YES”), then the method returns to 610 to perform further offline self-supervised learning of the model. If the performance score is not below a minimum threshold or, in other words, satisfies the minimum threshold (“NO”), then the method proceeds to 650.

Method 600 then proceeds to block 650 with determining whether or not the performance of the model is satisfactory. Stated differently, the determination is whether or not the model's performance satisfies a predetermined threshold. The determination involves computing a performance score for the language model 120 given test data and comparing the performance score to the predetermined threshold. In one implementation, the performance score computed to determine whether performance is below a minimum can also be utilized to determine if performance is satisfactory. If the performance score satisfies the predetermined threshold, the performance can be deemed satisfactory. If the performance is satisfactory (“YES”), then the method 600 advances to 660. If the performance score fails to satisfy the predetermined threshold, then the performance can be deemed unsatisfactory. If the performance is unsatisfactory (“NO”), the method 600 returns to 630.

Method 600 then proceeds to block 660 with deploying the model to interact directly with users or customers. In one instance, the language model 120 can be deployed in a limited way, such as for one percent of customer input. For instance, data input associated with the lowest-scoring or poorest-performing human agent can be routed to the language model 120. Additionally, or alternatively, the language model 120 can be deployed for tasks that may be deemed easy to handle, such as a password reset or tracking a package.

Method 600 then proceeds to block 670 with determining whether the language model 120 performs below a predetermined minimum acceptable threshold. The determination involves computing a performance score for the language model 120 based on test data and the similarity of responses provided by the language model 120 to the responses provided by human customer service agents. If the performance score fails to satisfy a minimum performance threshold, the language model 120 is deemed to perform below a minimum. If the performance is below a minimum (“YES”), the language model 120 is removed from deployment and training continues at block 630. If the performance score satisfies the minimum performance threshold (performance is not below the minimum (“NO”)), then the method 600 continues responding to customer input at block 660.

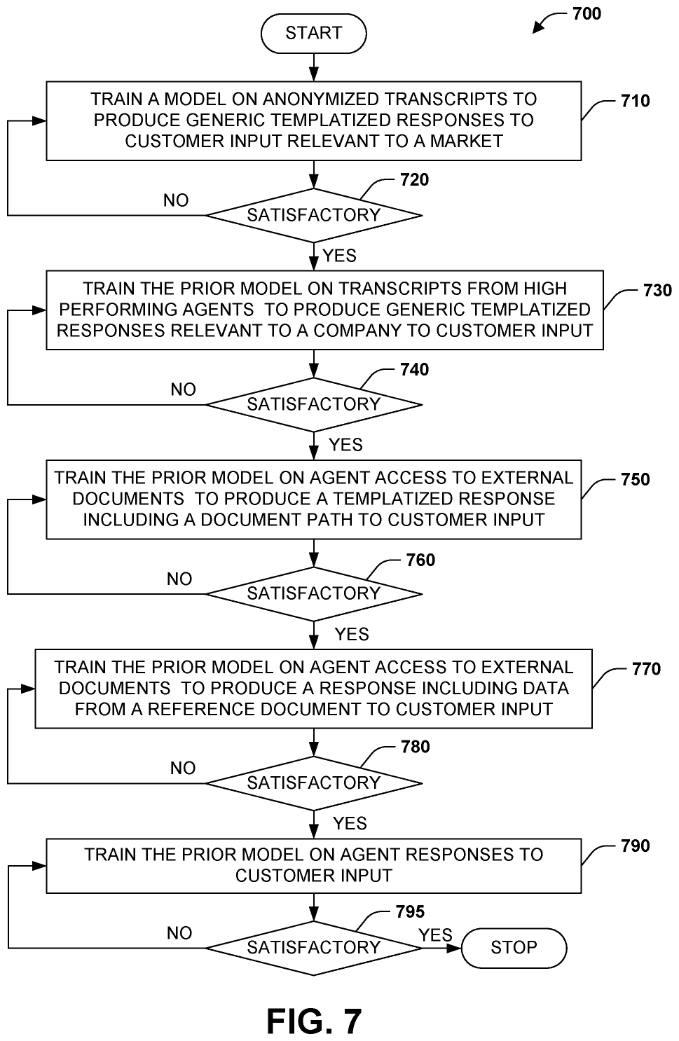

FIG. 7 is a flow chart diagram of an example method 700 of an offline training phase. The method 700 can be implemented by the phased automatic training system 130 of FIG. 1 for offline updating a language model 120 for use as an intelligent virtual assistant.

Method 700 begins at block 710 with updating a model on anonymized transcripts to produce generic templatized responses to customer input that is relevant to a market.

In one instance, a pre-trained language model 120 can be employed as a phase zero model. The pre-trained model is trained on a generic dataset and knows nothing about a particular company, enterprise, or domain. Training data associated with a specific industry or market can be acquired. For example, the training data can be anonymized data associated with different insurance companies. The model is not trained to generate names, locations, times, amounts, or other particulars, but instead generates generic entity placeholders in its responses.

By way of example, a training response can be transformed from “Agent: Thank you so much for holding. I see that we currently have an offer where you can save $15 a month, if you will sign up for another year contract. Would you be interested in this offer?” to “Agent: Thank you so much for holding. I see that we currently have an offer where you can save {usd} a {time_period}, if you sign up for another {time_period} contract. Would you be interested in this offer?” These templatized responses can be provided to a self-supervised learning task (e.g., masked language modeling (MLM), sentence reordering) to train the language model 120 to take in the customer inputs and respond with the generic templatized agent responses that are not specific to a particular company, but relevant to a business area such as insurance, telecommunications, or travel.

Method 700 then proceeds to block 720 with checking if performance is satisfactory. Whether the performance of a language model 120 is satisfactory or not can be determined by feeding the model test data and computing a performance score based on how close the model's predictions are to those of a human. The performance score can then be compared against a predetermined threshold. If performance is unsatisfactory (“NO”), then the method 700 returns to block 710 to continue updating the model. If performance is satisfactory (“YES”), then the method proceeds to block 730.

At block 730, the prior model is updated with on transcripts from high-performing agents to produce generic templated responses relevant to a particular company to customer input. Company-specific transcripts originating from a set of predetermined high-performing agents can be processed to remove any customer or conversation-specific entities from agent responses and replace them with generic entity placeholders (e.g. tags). Self-supervised learning techniques, such as masked learning modeling and sentence reordering, among others, can use the cleansed transcripts to train or update the model. Updating the model in this way adds domain-specific terminology and response structures.

Method 700 then proceeds to block 740 with checking if performance is satisfactory. The model can be fed test data to enable performance evaluation. The test data includes input, output, and predicted output from the model. Model performance can be determined based on the difference between the predicted output and the output. In one instance, the difference can be characterized by a similarity score. In another instance, the difference can be described as an error distance. Regardless, a model performs better when the difference is small and worse when the difference is large. A predetermined threshold can define what is and is not satisfactory performance. The difference can be compared to the predetermined threshold to make the determination. If performance is unsatisfactory (“NO”), then the method returns to block 730 to continue updating the model. If performance is satisfactory (“YES”), then the method proceeds to block 750.

At block 750, the prior model is updated on agent access to external documents to produce a templatized response to customer input, including a document path.

Agent actions and their text or speech in transcripts can be recorded. These actions include all external documents and database entries accessed by the agent during a conversation. Each action can be timestamped and associated with generating a specific response by overlaying the agent actions on top of agent responses by timestamps. Actions can be classified as document retrieval, application access, and data access, among other things, with class labels automatically generated when the agent acts. For example, if an agent reads a PDF file, the action is logged with the label of document retrieval, the PDF file name, the timestamp, and any other metadata needed to fetch the PDF file, such as file location or knowledge base entry identifier. In this phase, the language model is trained to recover agent responses as well as which documents and actions to perform at which point in the conversation. The language model learns not only to generate an appropriate response but also to locate a correct file used to find entities in the response and any location information needed to find the file. The model learns to generate an appropriate response and the correct file used to find the entities in the response and any location information needed to find the file. For example, a response could be “<s>Agent: Thank you so much for holding. I see that we currently have an offer where you can save {usd} a {time_period}, if you sign up for another {time_period} contract. Would you be interested in this offer?</s><reference> {name: 2022_current_offers.pdf, location: KBID1234}</reference>”

Method 700 then proceeds to block 760 with determining whether the model's performance is satisfactory. The model can be subject to testing, and the results can be compared with the results provided by the test to determine the model's performance score or error distance. The score or instance can be compared with a predetermined performance threshold to make the determination. If the performance is unsatisfactory (“NO”), the method returns to 750 where model updating continues. If performance is satisfactory (“YES”), the method 600 advances to 770.

Method 700 then proceeds to block 770 with updating the prior model on agent access, including external documents, to produce a response with data from a reference document to the customer input. The language model 120 can be fed the conversation and associated actions, but the output should be rendered using the output action. The same language model 120 can perform this, or a separate rendering model can be trained to accept a string template and document or data and render a response. The model is updated based on the human agent responses in template form and real event logs with correct paths, file names, and applications. The model learns to open an appropriate file or query the appropriate knowledge base or database and extract the referenced data to render the template response to match a human customer service agent response. The model learns to retrieve facts from various sources and inject them into responses correctly.

Method 700 then proceeds to block 780 with performing a performance check to determine whether performance is satisfactory. The performance check can pertain to measuring the ability of the language model 120 to render data from sources into a response. If performance is satisfactory (“YES”), then the method 700 continues at block 790. If performance is unsatisfactory (“NO”), then the method 700 returns to block 770 to update the model further.

Method 700 continues at block 790, where the prior model updated based on agent responses to customer input. Conversations and action data from a pool of agents designated to learn from can be used to train or update the language model 120. In operation, the language model 120 can attempt to generate a templated response and action for each customer input or event. The model can then attempt to use its own output and actions to render the final response.

At block 795, model performance is again evaluated to determine whether it is satisfactory. Performance can be determined by comparing the final rendered response to an agent's response. Performance can be deemed satisfactory if the difference between responses satisfies a predetermined threshold. However, if the difference fails to satisfy the predetermined threshold, performance can be said to be unsatisfactory. If the performance is unsatisfactory (“NO”), the method 700 can proceed to block 790 where updating of the model can continue. However, if the performance is satisfactory (“YES”), the offline training and updating process terminates successfully.

Although not illustrated, it should be appreciated that the method 700 can determine performance for a generated template response compared to a human template response and generated actions compared to human-generated actions. If performance is unsatisfactory, then the method 700 returns to training that is focused on that aspect that is unsatisfactory.

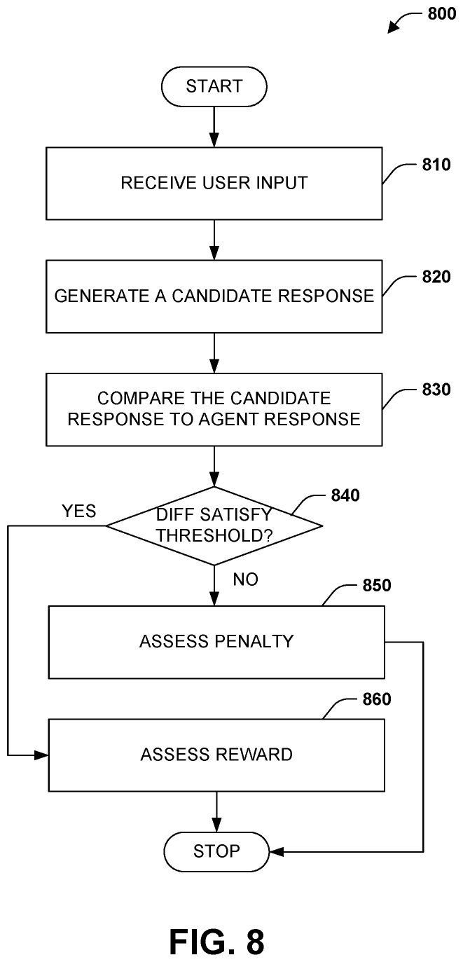

FIG. 8 depicts a flow chart of an example method 800 of online training (e.g., associated with an online training phase as described above with respect to FIG. 2). The method 800 can be performed by the phased automatic training system 130 as described above with respect to FIG. 1.

The method 800 begins at block 710 with receiving user or customer input.

Method 800 then proceeds to block 820 with generating a candidate response to the user input.

Method 800 then proceeds to block 830 with comparing the candidate response to the agent response.

Method 800 then proceeds to block 840 with determining whether a difference between the candidate and agent responses satisfies a predetermined threshold. If the difference fails to satisfy the threshold (“NO”), then the method 800 continues to block 850, where a penalty is assessed. If the difference does satisfy the predetermined threshold (“YES”), then the method 800 continues to 860 where a reward is accessed. Assessment of a reward or penalty can be utilized in a reinforcement learning environment to update the language model 120 in a way that seeks to maximize reward or minimize penalty.

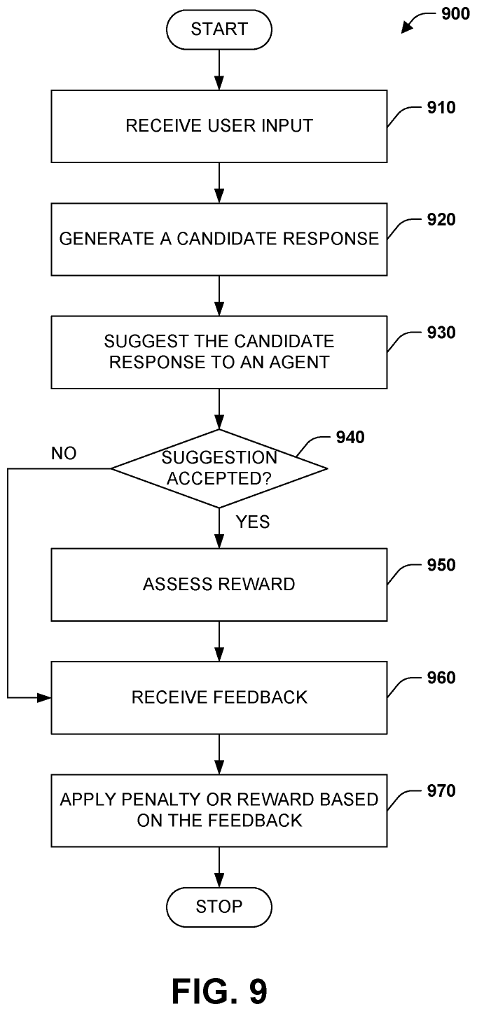

FIG. 9 is a flow chart diagram of another example method 900 of an online training associated with an online training phase. The method 900 can be performed by the phased automatic training system 130 as described above with respect to FIG. 1.

The method 900 begins at block 910 with receiving user or customer input, for instance in real time.

The method continues at block 920 with generating a candidate response to the user input.

The method 900 proceeds at block 930 with providing the candidate response to an agent as a candidate response.

The method 900 continues at block 940 with determining whether the agent accepted the candidate response. In other words, the determination concerns whether the agent returned the candidate response as the response to the user input. If it is determined that the candidate response was accepted (“YES”), then the method 900 continues to block 950, with assessing an award. If it is determined that the suggestion was not accepted (“NO”), then the method continues to block 960.

The method 900 proceeds to block 960 with receiving feedback from an agent regarding the suggestion. The feedback can be a rating or classification (e.g., thumbs up/down, five stars) can be positive or negative.

The method 900 continues to 970 with applying a penalty or reward based on the feedback. In the context of reinforcement learning, a reward or penalty can update the language model 120 in a manner that seeks to maximize the reward and minimize the penalty.

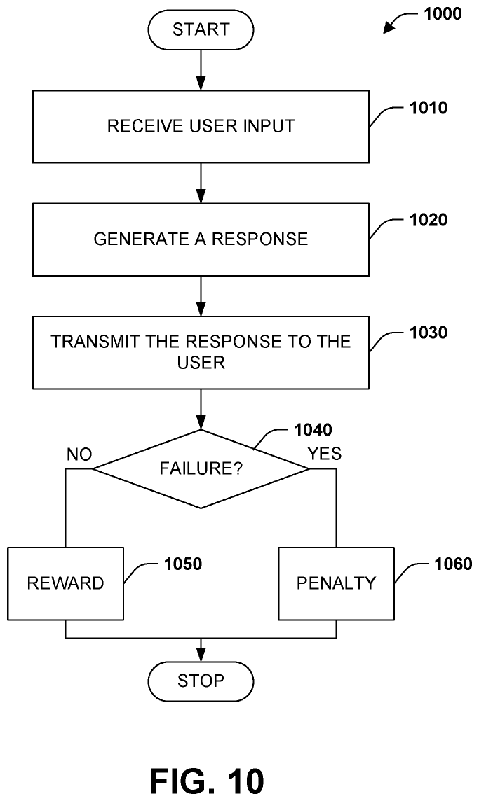

FIG. 10 is a flow chart diagram of an example method 1000 of online training in conjunction with an online training phase. The method 1000 can be performed by the phased automatic training system 130 as described above with respect to FIG. 1.

The method 1000 begins at block 1010 with receiving user or customer input.

The method 1000 continues at block 1020 with generating a response to the user

The method 1000 proceeds at block 1030 with transmitting the response to the user.

The method 1000 continues at block 1040 with determining whether failure occurred. The determination can be based on indirect or direct feedback from a user. Indirect feedback can correspond to the conversation terminating normally or abnormally or if the conversation is escalated to a human customer service agent. Further, a mechanism can be provided to users to rate or otherwise comment on responses. For example, the user can give results a thumbs up or down or rate the response on a scale of one to five. If the method 1000 it is determined that no failure occurred based on the feedback (“NO”), then the method 1000 can continue at block 1050, with assessing a reward for the response. If, based on feedback, it is determined that failure did occur (“YES”), then the method 1000 can continue at 1060 with assessing a penalty for the response. In the context of reinforcement learning, a reward or penalty can be employed to update the language model 120 in a manner that seeks to maximize the reward and minimize the penalty.

### Example Processing Environment for Phased Training of an IVA

While the above-disclosed system and methods can be described in the general context of computer-executable instructions of a program that runs on one or more computers, those skilled in the art will recognize that aspects can also be implemented in combination with other program modules or the like. Generally, program modules include routines, programs, components, and data structures, among other things, which perform particular tasks and/or implement particular abstract data types. Moreover, those skilled in the art will appreciate that the above systems and methods can be practiced with various computer system configurations, including single-processor, multi-processor, or multi-core processor computer systems, mini-computing devices, server computers, as well as personal computers, hand-held computing devices (e.g., personal digital assistant (PDA), smartphone, tablet, watch . . . ), microprocessor-based or programmable consumer or industrial electronics, and the like. Aspects can also be practiced in distributed computing environments where tasks are performed by remote processing devices linked through a communications network. However, some, if not all, aspects of the disclosed subject matter can be practiced on standalone computers. In a distributed computing environment, program modules can be located in one or both of local and remote memory devices.

FIG. 11 depicts an example computing device 1100 (e.g., desktop, laptop, tablet, watch, server, hand-held, programmable consumer or industrial electronics, set-top box, game system, compute node). The computing device 1100 includes one or more processor(s) 1110, memory 1120, system bus 1130, storage device(s) 1140, input device(s) 1150, output device(s) 1160, and communications connection(s) 1170. The system bus 1130 communicatively couples at least the above system constituents. However, the computing device 1100, in its simplest form, can include one or more processors 1110 coupled to memory 1120, wherein the one or more processors 1110 execute various computer-executable actions, instructions, and or components stored in the memory 1120.

The processor(s) 1110 can be implemented with a general-purpose processor, a digital signal processor (DSP), an application-specific integrated circuit (ASIC), a field-programmable gate array (FPGA) or other programmable logic device, discrete gate or transistor logic, discrete hardware components, or any combination thereof designed to perform the functions described herein. A general-purpose processor can be a microprocessor, but in the alternative, the processor can be any processor, controller, microcontroller, or state machine. The processor(s) 1110 can also be implemented as a combination of computing devices, for example, a combination of a DSP and a microprocessor, a plurality of microprocessors, multi-core processors, one or more microprocessors in conjunction with a DSP core, or any other such configuration. In one embodiment, the processor(s) 1110 can be a graphics processor unit (GPU) that performs calculations concerning digital image processing and computer graphics.

The computing device 1100 can include or otherwise interact with a variety of computer-readable media to facilitate control of the computing device to implement one or more aspects of the disclosed subject matter. The computer-readable media can be any available media accessible to the computing device 1100 and includes volatile and nonvolatile media, and removable and non-removable media. Computer-readable media can comprise two distinct and mutually exclusive types: storage media and communication media.

Storage media includes volatile and nonvolatile, removable and non-removable media implemented in any method or technology to store information such as computer-readable instructions, data structures, program modules, or other data. Storage media includes storage devices such as memory devices (e.g., random access memory (RAM), read-only memory (ROM), electrically erasable programmable read-only memory (EEPROM)), magnetic storage devices (e.g., hard disk, floppy disk, cassettes, tape), optical disks (e.g., compact disk (CD), digital versatile disk (DVD) . . . ), and solid-state devices (e.g., solid-state drive (SSD), flash memory drive (e.g., card, stick, key drive)), or any other like mediums that store, as opposed to transmit or communicate, the desired information accessible by the computing device 1100. Accordingly, storage media excludes modulated data signals as well as that which is described with respect to communication media.

Communication media embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency (RF), infrared, and other wireless media.

The memory 1120 and storage device(s) 1140 are examples of computer-readable storage media. Depending on the configuration and type of computing device, the memory 1120 can be volatile (e.g., random access memory (RAM)), nonvolatile (e.g., read-only memory (ROM), flash memory . . . ), or some combination of the two. By way of example, the basic input/output system (BIOS), including basic routines to transfer information between elements within the computing device 1100, such as during start-up, can be stored in nonvolatile memory, while volatile memory can act as external cache memory to facilitate processing by the processor(s) 1110, among other things.

The storage device(s) 1140 include removable/non-removable, volatile/nonvolatile storage media for storing vast amounts of data relative to the memory 1120. For example, storage device(s) 1140 include, but are not limited to, one or more devices such as a magnetic or optical disk drive, floppy disk drive, flash memory, solid-state drive, or memory stick.

Memory 1120 and storage device(s) 1140 can include, or have stored therein, operating system 1180, one or more applications 1186, one or more program modules 1184, and data 1182. The operating system 1180 acts to control and allocate resources of the computing device 1100. Applications 1186 include one or both of system and application software and can exploit management of resources by the operating system 1180 through program modules 1184 and data 1182 stored in the memory 1120 and/or storage device(s) 1140 to perform one or more actions. Accordingly, applications 1186 can turn a general-purpose computer 1100 into a specialized machine according to the logic provided.

All or portions of the disclosed subject matter can be implemented using standard programming and/or engineering techniques to produce software, firmware, hardware, or any combination thereof to control the computing device 1100 to realize the disclosed functionality. By way of example and not limitation, all or portions of phased automatic training system 130 can be, or form part of, the application 1186 and include one or more modules 1184 and data 1182 stored in memory and/or storage device(s) 1140 whose functionality can be realized when executed by one or more processor(s) 1110.

In accordance with one particular embodiment, the processor(s) 1110 can correspond to a system on a chip (SOC) or like architecture including, or in other words integrating, both hardware and software on a single integrated circuit substrate. Here, the processor(s) 1110 can include one or more processors as well as memory at least similar to the processor(s) 1110 and memory 1120, among other things. Conventional processors include a minimal amount of hardware and software and rely extensively on external hardware and software. By contrast, a SOC implementation of a processor is more powerful, as it embeds hardware and software therein that enable particular functionality with minimal or no reliance on external hardware and software. For example, phased automatic training system 130 or functionality associated therewith can be embedded within hardware in a SOC architecture.

The input device(s) 1150 and output device(s) 1160 can be communicatively coupled to the computing device 1100. By way of example, the input device(s) 1150 can include a pointing device (e.g., mouse, trackball, stylus, pen, touchpad), keyboard, joystick, microphone, voice user interface system, camera, motion sensor, and a global positioning satellite (GPS) receiver and transmitter, among other things. The output device(s) 1160, by way of example, can correspond to a display device (e.g., liquid crystal display (LCD), light emitting diode (LED), plasma, organic light-emitting diode display (OLED) . . . ), speakers, voice user interface system, printer, and vibration motor, among other things. The input device(s) 1150 and output device(s) 1160 can be connected to the computing device 1100 by way of wired connection (e.g., bus), wireless connection (e.g., Wi-Fi, Bluetooth), or a combination thereof.

The computing device 1100 can also include communication connection(s) 1170 to enable communication with at least a second computing device 1102 utilizing a network 1190. The communication connection(s) 1170 can include wired or wireless communication mechanisms to support network communication. The network 1190 can correspond to a personal area network (PAN), local area network (LAN), or a wide area network (WAN) such as the internet. In one instance, the computing device 1100 can correspond to a first computing device executing the phased automatic training system 130 associated with an intelligent virtual assistant. The second computing device 1102 can correspond to a user computing device on which the user provides input, such as inquiries, to the intelligent virtual assistant. In another instance, aspects of the phased automatic training system 130 can be distributed across the computing device 1100 and the second computing device 1102. For example, offline training can be provided by a computing device different from the computing device that performs online training.

FIG. 11 provide a brief, general description of a suitable environment in which various aspects of the disclosed subject matter can be implemented. However, the suitable environment is solely an example and is not intended to suggest any limitation on the scope of use or functionality.

### Example Clauses

Implementation examples are described in the following numbered clauses:

Clause 1: A method of generating an intelligent virtual assistant, comprising: updating a pre-trained language model 120 offline to produce a second language model 120 with self-supervised learning based on transcripts of historical interactions between one or more customers, one or more customer service agents, and one or more data stores, determining that the second language model 120 satisfies a predetermined performance threshold, updating the second language model 120 online to produce a third language model 120 with reinforcement learning based on received customer input and a similarity between a response provided by a customer service agent and a predicted response generated by the second language model 120, and deploying the third language model 120 to respond to received user input.

Clause 2: The method of Clause 1, further comprising: generating a generic entity placeholder for at least one aspect in the transcripts of historical interactions associated with a subset of customer service agents and updating the pre-trained language model using the transcripts with the self-supervised learning to generate a response template with the generic entity placeholder.

Clause 3: The method of any one of Clauses 1-2, further comprising: identifying a data retrieval action of a customer service agent within a conversation in one or more transcripts; adding reference information associated with the data retrieval action in the one or more transcripts; and updating the pre-trained language model using the one or more transcripts with the self-supervised learning to generate the response template with the reference information.

Clause 4: The method of any one of Clauses 1-3, further comprising: updating the pre-trained language model to generate a complete response using the reference information to populate one or more entity placeholders in the response template.

Clause 5: The method of any one of Clauses 1-4, further comprising: detecting one or more errors that fail to satisfy a second predetermined performance threshold based on historical user input and comparison of the complete response with a response to a customer service agent and initiating additional offline updating of the pre-trained language model.

Clause 6: The method of any one of Clauses 1-5, further comprising computing a performance score of the third language model based on one or more feedback signals associated with user interaction.

Clause 7: The method of any one of Clauses 1-6, further comprising: deploying the third language model to respond to a subset of the additional received user input, and adjusting subset size based on the performance score.

Clause 8: The method of any one of Clauses 1-7, further comprising: determining that the performance score fails to satisfy a predetermined minimum threshold, and initiating further updating of the third language model.

Clause 9: An intelligent virtual assistant method, comprising: receiving a user input, invoking a language model to infer a response to the user input, the language model having been trained by: updating a pre-trained language model offline to produce a second language model with self-supervised learning based on transcripts of historical interactions between one or more customers, one or more customer service agents, and one or more data stores, determining that the second language model satisfies a predetermined performance threshold, updating the second language model online to produce a third language model with reinforcement learning based on received customer input and similarity between a response provided by a customer service agent and a predicted response generated by the second language model, outputting the response to the user input.

Clause 10: The method of Clause 9, further comprising: computing a performance score of the language model based on one or more feedback signals associated with user interaction.

Clause 11: The method of any one of Clauses 9-10, further comprising: determining that the performance score fails to satisfy a predetermined minimum threshold and initiating further training of the language model.

Clause 12: A processing system, comprising: a memory comprising computer-executable instructions; and a processor configured to execute the computer-executable instructions and cause the processing system to perform a method in accordance with any one of Clauses 1-11.

Clause 13: A processing system, comprising means for performing a method in accordance with any one of Clauses 1-11.

Clause 14: A non-transitory computer-readable medium comprising computer-executable instructions that, when executed by a processor of a processing system, cause the processing system to perform a method in accordance with any one of Clauses 1-11.

Clause 15: A computer program product embodied on a computer-readable storage medium comprising code for performing a method in accordance with any one of Clauses 1-11.

### Additional Considerations

The preceding description is provided to enable any person skilled in the art to practice the various embodiments described herein. The examples discussed herein are not limiting of the scope, applicability, or embodiments set forth in the claims. Various modifications to these embodiments will be readily apparent to those skilled in the art, and the generic principles defined herein may be applied to other embodiments. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The term “customer” is used herein in the context of historical interactions between customers and customer service agents. The term “customer” as used herein can refer to an individual who purchased goods or services or a potential customer who has not purchased goods or services but is willing and capable of purchasing goods or services.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the embodiments shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112 (f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. An intelligent virtual assistant system, comprising:
a processor coupled to a memory that stores instructions that, when executed by the processor, cause the processor to:
update a pre-trained language model offline to produce a second language model with self-supervised learning based on transcripts of historical interactions between one or more customers, one or more customer service agents, and one or more data stores;
determine that the second language model satisfies a predetermined performance threshold;
update the second language model online to produce a third language model with reinforcement learning based on received customer input and a similarity between a response provided by a customer service agent and a predicted response generated by the second language model; and
deploy the third language model to respond to received user input.

2. The intelligent virtual assistant system of claim 1, wherein the instructions further cause the processor to:
generate a generic entity placeholder for at least one aspect in the transcripts of historical interactions associated with a subset of customer service agents; and
update the pre-trained language model using the transcripts with the self-supervised learning to generate a response template with the generic entity placeholder.

3. The intelligent virtual assistant system of claim 2, wherein the instructions further cause the processor to:
identify a data retrieval action of a customer service agent within a conversation in one or more transcripts;
add reference information associated with the data retrieval action in the one or more transcripts; and
update the pre-trained language model using the one or more transcripts with the self-supervised learning to generate the response template with the reference information.

4. The intelligent virtual assistant system of claim 3, wherein the instructions further cause the processor to update the pre-trained language model to generate a complete response using the reference information to populate one or more entity placeholders in the response template.

5. The intelligent virtual assistant system of claim 4, wherein the instructions further cause the processor to:
detect one or more errors that fail to satisfy a second predetermined performance threshold based on historical customer input and comparison of the complete response with a response to a customer service agent; and
initiate additional offline updating of the pre-trained language model.

6. The intelligent virtual assistant system of claim 1, wherein the instructions further cause the processor to compute a performance score of the third language model based on one or more feedback signals associated with user interaction.

7. The intelligent virtual assistant system of claim 6, wherein the instructions further cause the processor to:
deploy the third language model to respond to a subset of the additional received user input; and
adjust subset size based on a performance score.

8. The intelligent virtual assistant system of claim 6, wherein the instructions further cause the processor to:
determine that the performance score fails to satisfy a predetermined minimum threshold; and
initiate further updating of the third language model.

9. The intelligent virtual assistant system of claim 1, wherein the instructions further cause the processor to update the second language model online based on customer service agent feedback.

10. A method of generating an intelligent virtual assistant, comprising:
updating a pre-trained language model offline to produce a second language model with self-supervised learning based on transcripts of historical interactions between one or more customers, one or more customer service agents, and one or more data stores;
determining that the second language model satisfies a predetermined performance threshold;
updating the second language model online to produce a third language model with reinforcement learning based on received customer input and a similarity between a response provided by a customer service agent and a predicted response generated by the second language model; and
deploying the third language model to respond to received user input.

11. The method of claim 10, further comprising:
generating a generic entity placeholder for at least one aspect in the transcripts of historical interactions associated with a subset of customer service agents; and
updating the pre-trained language model using the transcripts with the self-supervised learning to generate a response template with the generic entity placeholder.

12. The method of claim 11, further comprising:
identifying a data retrieval action of a customer service agent within a conversation in one or more transcripts;
adding reference information associated with the data retrieval action in the one or more transcripts; and
updating the pre-trained language model using the one or more transcripts with the self-supervised learning to generate the response template with the reference information.

13. The method of claim 12, further comprising updating the pre-trained language model to generate a complete response using the reference information to populate one or more entity placeholders in the response template.

14. The method of claim 13, further comprising:
detecting one or more errors that fail to satisfy a second predetermined performance threshold based on historical customer input and comparison of the complete response with a response to a customer service agent; and
initiating additional offline updating of the pre-trained language model.

15. The method of claim 10, further comprising computing a performance score of the third language model based on one or more feedback signals associated with user interaction.

16. The method of claim 15, further comprising:
deploying the third language model to respond to a subset of the additional received user input; and
adjusting subset size based on the performance score.

17. The method of claim 15, further comprising:
determining that the performance score fails to satisfy a predetermined minimum threshold; and
initiating further updating of the third language model.

18. An intelligent virtual assistant method, comprising:
receiving a user input;
invoking a language model to infer a response to the user input, the language model having been trained by:
updating a pre-trained language model offline to produce a second language model with self-supervised learning based on transcripts of historical interactions between one or more customers, one or more customer service agents, and one or more data stores;
determining that the second language model satisfies a predetermined performance threshold;
updating the second language model online to produce a third language model with reinforcement learning based on received customer input and similarity between a response provided by a customer service agent and a predicted response generated by the second language model; and
outputting the response to the user input.

19. The method of claim 18, further comprising computing a performance score of the language model based on one or more feedback signals associated with user interaction.

20. The method of claim 19, further comprising:
determining that the performance score fails to satisfy a predetermined minimum threshold; and
initiating further training of the language model.
